(19) United States
(12) Patent Application Publication
(10) Pub. No.: US 2025/0342629 A1
(43) Pub. Date: Nov. 6, 2025

(54) SYSTEMS AND METHODS FOR INTERACTIVE DIGITAL OVERLAYMENT

(71) Applicants: Alexis Cuban, Dallas, TX (US); Mark Cuban, Dallas, TX (US); Phyllis Jager, New York, NY (US); Barry Terach, Goshen, NY (US)

(72) Inventors: Alexis Cuban, Dallas, TX (US); Mark Cuban, Dallas, TX (US); Phyllis Jager, New York, NY (US); Barry Terach, Goshen, NY (US)

(73) Assignee: ZuMedia Inc., New York, NY (US)

(21) Appl. No.: 18/655,224

(22) Filed: May 3, 2024

(51) Int. Cl. G06T 11/60; H04N 5/272

(52) U.S. Cl. CPC G06T 11/60; H04N 5/272; G06T 2200/24

(57) ABSTRACT

An overlay image system and methods for overlaying an image over another is disclosed. The system can comprise an upload device for capturing an image, converting the image to a digital file to be used as an overlay, to request a download device to download the digital file, and to upload the digital file by an upload device for the download device; the download device for receiving a download request for the digital file from the upload device, downloading the digital file transmitted by the upload device; a processor connected to the download device for overlaying the digital file on an original digital file as instructed by a user.

### FIELD OF THE DISCLOSURE

The present disclosure relates to exemplary embodiments of systems and methods for providing the use of a digital overlayment, and more particularly, to exemplary embodiments of systems and methods for providing overlayments of webpages, digital videos, digital images, virtual reality constructs, augmented reality constructs, and other digital audio, visual, or audio visual content.

### BACKGROUND

Published digital images and audio are generally immutable, and do not provide rich interactive capabilities for lay people. Yet, we are exposed to this digital content in all aspects of our lives through the digital devices we use, e.g. smart phones, Internet enabled devices, smart TVs. We hear and view this content at home, while traveling, and at places of work. The content is used for advertising, communication, art, and many other reasons.

This content has little to no interactive capabilities. Some of this content allows the person experiencing it (the subject) to manipulate certain characteristics in the content but there is no means for a more rich interactive experience. As used herein, a user is an entity, processor, AI, or person that experiences digital image and sound content; a device can be a processor or multiple processors, but is not limited to such, e.g. a display. A processor can be one or more processors.

### SUMMARY

In accordance with the present disclosure, there is an overlay image system comprising (1) an upload device for capturing an image or sound, converting the image or sound to a temporary array to be used as an overlay, requesting a download device to download the digital file, pushing the digital file to the download device; (2) the download device for receiving a download request for the temporary array file from the upload device and downloading the digital file transmitted by the upload device, and; a processor connected to the download device for overlaying the temporary array file on an original digital file stored or streaming on the download device as instructed by a user.

An overlay image can be a digital image (e.g., jpeg) or a digital video (e.g., mpeg). An overlayment can also be a digital audio file (e.g., mp3). Other types of content can also be used as overlay data.

The overlayment can comprise any type of user interface element (e.g., .jpeg), that can overlay another element of digital content (e.g. a HyperText Markup Language (HTML) element of HTML5 that uses <canvas> tags, which may be contained in <div> tags).

In accordance with the present disclosure, a method is disclosed comprising, responsive to a user input, identifying content to overlay the content of a displayed or otherwise published digital content; creating a temporary array and populating the temporary array with the identified content for overlayment; transforming the temporary array into the digital content overlayment at an identified area of the content of the displayed or otherwise published digital content.

The content can be sound, a video, text, static image, live video, live or recorded streams, live or recorded broadcasts, or other known content types.

A computer device is disclosed comprising a processor; and memory comprising processor-executable instructions that when executed by the processor cause performance of operations, the operations comprising: identifying content to overlay the content of digital content displayed or otherwise published through a user interface; creating a temporary array; populating the temporary array with the identified content for overlayment; responsive to an input, transforming the temporary array into the populated overlayment.

A non-transitory machine readable medium is disclosed having stored thereon processor-executable instructions that when executed cause performance of operations, the operations comprising: tracking a position of a pointer; responsive to receiving a first selection input while the position of the pointer corresponds to a position on a display of digital content, the first digital content selected by use of the pointer is added to a temporary array; responsive to receiving a second selection input from the pointer, overlaying the first digital content from the temporary array on to the second selection input.

### BRIEF DESCRIPTION OF THE DRAWING

FIG. 1 is an example of a system for overlaying an image.

FIG. 2. an example of automatically capturing facial content to be used as an overlayment.

FIG. 3. is a schematic representation of a system for creating a digital interactive overlayment.

FIG. 4. is a schematic representation of a client device.

FIG. 5. is a schematic representation of a system for creating and displaying an overlayment.

### DETAILED DESCRIPTION OF EXEMPLARY EMBODIMENTS OF DISCLOSURE

Subject matter will be described more fully herein with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted or may be handled in summary fashion.

The following subject matter can be embodied in a variety of different forms, such as methods, devices, components, or systems. Accordingly, this subject matter is not intended to be construed as limited to any example embodiments set forth herein. Rather, example embodiments are provided merely to be illustrative. Such embodiments can, e.g., take the form of hardware, software, firmware, or any combination thereof.

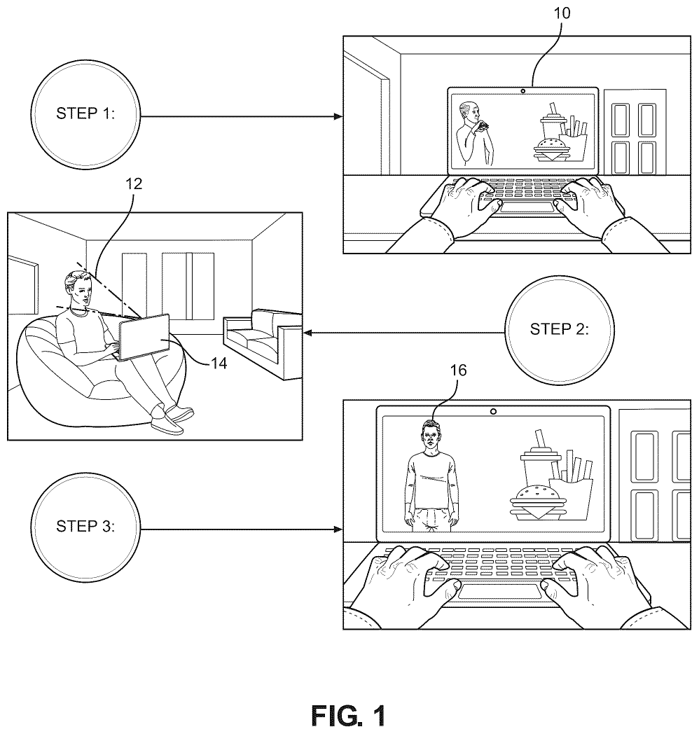

FIG. 1 is an embodiment of a system and method for inserting a customer or potential customer into an advertisement using an overlayment according to the technology presented herein. In Step 1, a digital advertisement is presented to a user 12 on a monitor 10. In Step 2 the users image is captured by a webcam and uploaded to a temporary array on an upload device 14 processor. In Step 3 the image from the temporary array is downloaded to a processor of the download device and used to overlay parts, or all, of the advertisement on the monitor.

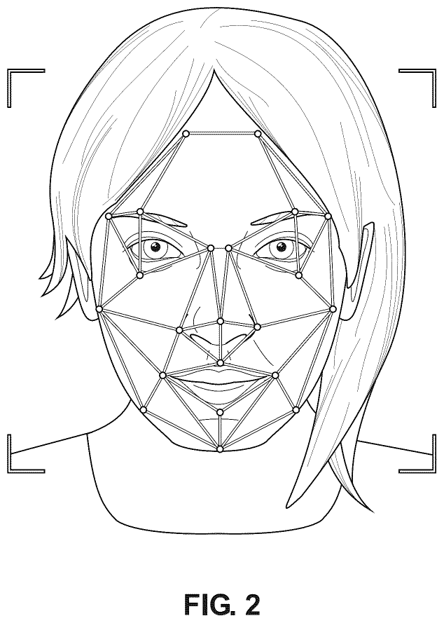

FIG. 2 is an example of automatically capturing content to be used as an overlayment. Automated facial recognition technology can use computer vision and machine learning algorithms to capture facial features. An initial step in facial recognition can be to detect and locate faces within an image or video stream. This can involve analyzing the input data and identifying regions that contain facial features. Techniques like Haar cascades or convolutional neural networks (CNNs) are commonly used for face detection.

Once a face is detected, the facial recognition system can align the face to a standardized position and orientation. This step helps normalize the facial features and reduce variations caused by pose, scale, or rotation. Face alignment algorithms may use facial landmarks or geometric transformations to ensure consistent alignment.

After alignment, the facial recognition system present on the input device extracts unique features from the face, often referred to as facial descriptors or face embedding. These features capture distinct patterns in the face, such as the arrangement of eyes, nose, and mouth, and encode them as numerical representations. Deep learning models, like CNNs or Siamese networks, are commonly used for feature extraction.

To create a facial recognition system, a large dataset of labeled face images can be used. This dataset is used to train a machine learning model. The model learns to extract facial feature information and create a temporary array where those features are placed.

This process can also be done semi-manually, i.e. a user can trace a pointer around the face of an image and indicate through an input signal that the closed trace is beginning and ending. The content that falls within this trace will then populate the temporary array.

Once this facial information is placed in the temporary array, the user (automatically when done by software or semi-manually when done by a person) can indicate where the information should be placed as an overlay.

Another embodiment provides for gesture recognition technology to identify and capture a full or partial image of a user for populating a temporary array. A sensor detects the user and the user's gestures as input data.

The collected data is preprocessed to extract relevant features that can be used to distinguish different gestures. This may involve extracting key points, landmarks, or motion trajectories from the input data. Various computer vision techniques, such as image processing or motion tracking, can be employed in this step.

The preprocessed data can be used to train a machine learning model. Popular techniques for gesture recognition include deep learning models like convolutional neural networks (CNNs) or recurrent neural networks (RNNs). The model learns to recognize patterns and relationships between the input data and the corresponding gestures through an iterative training process.

During training, the AI model learns to automatically extract relevant features from the input data. These features can include spatial information, temporal dynamics, or key pose configurations associated with specific gestures. The model's architecture and the complexity of the learned representations depend on the chosen neural network architecture and training methodology.

A trained AI model can be used to classify and recognize gestures. The model takes as input new video or image sequences, extracts the relevant features, and predicts the corresponding gesture label. This inference process involves applying the learned weights and biases within the trained model to make accurate predictions.

Gesture recognition AI models can be further enhanced through continuous learning and improvement. By incorporating user feedback and additional training data, the model's performance can be refined over time, leading to better recognition accuracy and generalization.

The specific implementation details and techniques can vary depending on the gesture recognition system and the complexity of the gestures being recognized. Advanced techniques like 3D pose estimation or multi-modal fusion (combining information from multiple sensors) can also be applied to improve the accuracy and robustness of gesture recognition systems.

The extracted relevant features from the video or image sequences, and predictions of the corresponding gesture label can be used to populate the temporary array for use as an overlayment. The overlayment can be dynamic and functioning in near real-time, overlaying an image with the images from the temporary array. Near Real-time means contemporaneously or within 1 second, or up to 30 seconds from initiation.

In another embodiment, a single-shot detector model can be used for detecting and recognizing a hands, face, or full body images in near real-time. The single-shot detector model can be used by MediaPipe.

In some embodiments, the images can been captured by the webcam in a laptop or PC. By using the Python computer vision library OpenCV, the video capture object can be created and the web camera can capture video. The web camera captures and passes the frames to the processor.

In some embodiments, the system and steps for inserting the user's recognized data into the overlayment are:

1. An uploading device acquires overlayment data. This can be an image or images, video, live stream, audio, or other data. Harmonized composite images can also be used. An uploading device can be a digital camera, a digital drawing device, a microphone, an audio file, or a processor that can download or stream overlayment data from the Internet or other storage systems.

2. The uploading device can make the overlayment data available as files for an overlayment storage server.

3. A file from the overlayment storage server is called on by a temporary array processor. The file populates a temporary array. E.g., for a live stream, this can be done continuously for a period of time.

4. An overlayment placement device acquires overlayment placement information, e.g. where on a live steam the temporary array data shall be placed. The placement device can be a pointer, controlled by a user or automatically, that is moved along the outline of an image.

5. The temporary array processor downloads the temporary array data to the overlayment placement device where a processor provides for its display where a user has indicated the overlayment should be placed or where it is predetermined to be placed.

The steps can be automated, semi-automated and manual.

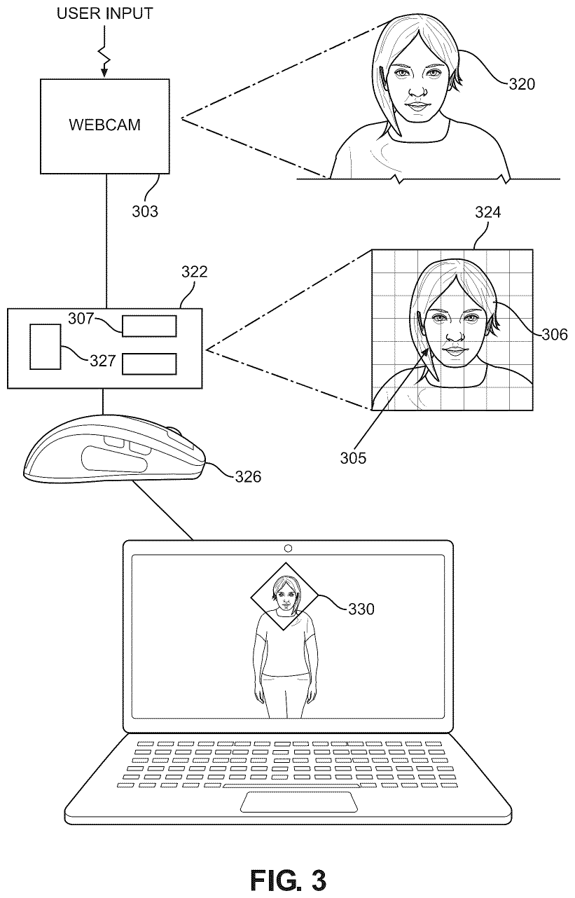

An embodiment of creating a digital interactive overlayment is illustrated in FIG. 3. Within a connected computer system, and responsive to receiving a user input, an uploading device 303, e.g. a webcam, can identify a subject 320, e.g. the user. The image of the subject 320 can be captured by the uploading device 303. A processor 322 of an uploading device 303 can create a temporary array 324 populated with the image from the uploading device. Responsive to a user input through a mouse 326 connected to the system, a pointer 305 identifies a portion of an output as overlayment placement information 306. While the position of the pointer 305 corresponds to a portion of the output (e.g., the user input corresponding to a touch gesture over a portion of a video), coordinates of the position of the pointer 305 (e.g., or of the touch gesture) can be transformed by a processor 307 into a lookup value, e.g., Cartesian coordinates of the position of the pointer (x, y) can be transformed by a processor into a linear lookup value of the temporary array (portion of subject's nose) because the temporary array can comprise a linear array of certain values. A value of the overlayment placement information can be determined, and an array position in the temporary array 324 corresponding to the lookup value, can be identified. Certain rules will apply based on the value of the array position of the overlayment placement information and the lookup value, e.g. overlay the overlayment placement 330 with the temporary array data.

A further embodiment provides for the overlayment data to be overlayed over digital moving images, e.g. video. A further embodiment provides for content-aware photo filters to be applied to the overlay image. Overlay images may also be automatically captured from any content digitally stored on an accessible server.

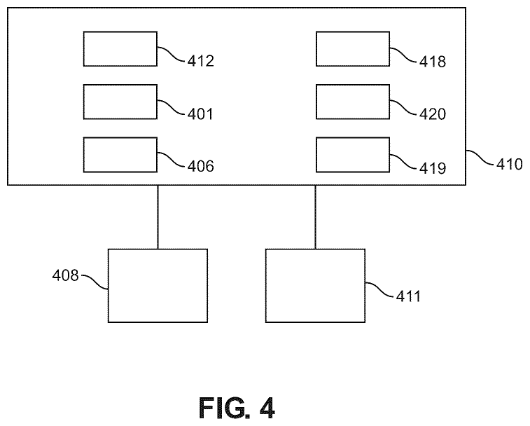

FIG. 4 presents a schematic architecture diagram 400 of an example of a client device 410 whereupon at least a portion of the techniques presented herein can be implemented. Such a client device 410 can vary widely in configuration or capabilities, in order to provide a variety of functionality to a user. The client device 410 can be provided in a variety of form factors, such as a desktop or tower workstation; an “all-in-one” device integrated with a display 408; a laptop, tablet, convertible tablet, or palmtop device; a wearable device mountable in a headset, eyeglass, earpiece, and/or wristwatch, an implantable device, any of these devices integrated with an article of clothing; and/or a component of a piece of furniture, such as a tabletop, and/or of another device, such as a vehicle or residence. The client device 410 can serve the user in a variety of roles, such as a workstation, kiosk, media player, gaming device, and/or appliance.

The client device 410 can comprise one or more processors 410 that process instructions. The one or more processors 412 can optionally include a plurality of cores; one or more coprocessors, such as a mathematics coprocessor or an integrated graphical processing unit (GPU); and/or one or more layers of local cache memory. The client device 410 can comprise memory 401 storing various forms of applications, such as an operating system; one or more user applications, such as document applications, media applications, file and/or data access applications, communication applications such as web browsers and/or email clients, utilities, and/or games; and/or drivers for various peripherals. The client device 410 can comprise a variety of peripheral components, such as a wired and/or wireless network adapter 406 connectible to a local area network and/or wide area network; one or more output components, such as a display 408 coupled with a display adapter (optionally including a graphical processing unit (GPU)), a sound adapter coupled with a speaker, and/or a printer; input devices for receiving input from the user, such as a keyboard 411, a mouse, a microphone, a camera, and/or a touch-sensitive component of the display 408; and/or environmental sensors, such as a global positioning system (GPS) receiver 419 that detects the location, velocity, and/or acceleration of the client device 410, a compass, accelerometer, and/or gyroscope that detects a physical orientation of the client device 410. Other components that can optionally be included with the client device 410 (though not shown in the schematic architecture diagram 400 of FIG. 4) include one or more storage components, such as a hard disk drive, a solid-state storage device (SSD), a flash memory device, and/or a magnetic and/or optical disk reader; and/or a flash memory device that can store a basic input/output system (BIOS) routine that facilitates booting the client device 410 to a state of readiness; and a climate control unit that regulates climate properties, such as temperature, humidity, and airflow.

The client device 410 can comprise a mainboard 420 featuring one or more communication buses that interconnect the processor 410, the memory 401, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 410 can comprise a dedicated and/or shared power supply 418 that supplies and/or regulates power for other components, and/or a battery 404 that stores power for use while the client device 410 is not connected to a power source via the power supply 418. The client device 410 can provide power to and/or receive power from other client devices.

In some embodiments, as a user interacts with a software application on a client device 410 (e.g., social media platform and/or electronic mail application), stored content in the form of signals or stored physical states within memory (e.g., photos, videos, date, and/or time) can be identified. Also, live content can be transferred, e.g., audio and video captured by a microphone and camera. The client device 410 can include one or more servers that can locally serve the client device 410 and/or other client devices of the user and/or other individuals, e.g., a locally installed webserver can provide content in response to locally submitted requests. Many such client devices 410 can be configured and/or adapted to utilize at least a portion of the techniques presented herein.

The client device 410 can be, contain, or can be connected to the upload device 303. The client device 410 therefore can access the overlayment data and transmit the overlayment data to the download device 305. The download device can also be a part of or be connected to the client device 410.

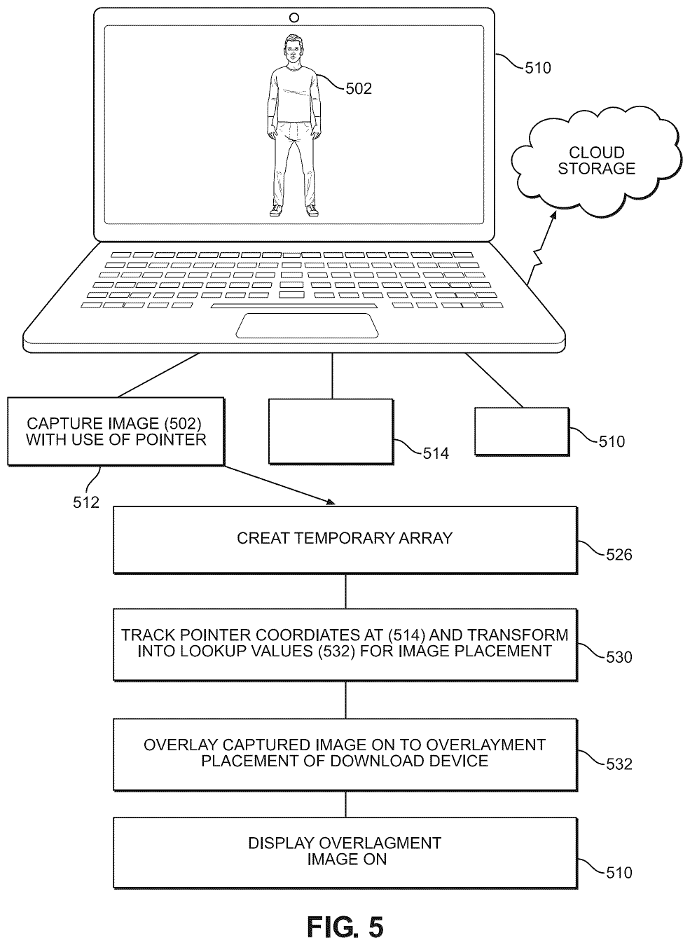

An embodiment of creating an interactive digital overlayment is illustrated by an example method 500 of FIG. 5. A client device 510 with an upload device 512 can provide overlayment data 502, e.g., a photo of a user that is accessible through a user interface of the upload device 512, to a download device 514. The upload device 512 and the download device 514 can be the same device. The overlayment data may be stored on a storage device 518 that can be either on the client device 510 or connected to the client device 510, e.g. cloud storage system. The image 502, being rendered within the upload device displayed through a user interface, can be identified.

At 526, a temporary array can be created. The temporary array can comprise a linear byte array. The temporary array can be populated with the overlayment data. At 530, the position of a pointer with respect to the overlayment placement information can be tracked (e.g., or a touch display can be monitored to identify user input, such as a touch gesture, with respect to the overlayment placement information), e.g., the pointer pixel image (e.g., a 2×2 pixel image or any other number or grouping/shape of pixels) can be created to represent the position of the pointer. A location of the pointer pixel image can be updated based upon changes in position of the pointer.

Responsive to receiving a user input while the position of the pointer corresponds to a portion of the overlayment placement information (e.g., or the user input corresponding to a touch gesture over a portion of a video), coordinates of the position of the pointer (e.g., or of the touch gesture) can be transformed into a lookup value, at 532, e.g. Cartesian coordinates of the position of the pointer can be transformed into a linear lookup value into the temporary array because the temporary array can comprise a linear array of certain values. At 530, a value of the overlayment placement information is determined (e.g., position on the underlayment), and an array position in the temporary array corresponding to the lookup value, can be identified. Certain rules can apply based on the value of the array position of the overlayment data and the lookup value.

At 532, responsive to the overlayment data value, an action can be performed, e.g., an image of the user is overlaid onto the identified content for overlayment placement information. This can then be displayed on the client device 510 or other locations.

The description of the various embodiments is merely exemplary in nature and is in no way intended to limit the scope of the disclosure, its application, or uses. Various considerations can also be addressed in the exemplary applications described according to the exemplary embodiments of the present disclosure, e.g., the software can be built into any domain platform.

As used in this application, “component,” “module,” “system”, “interface”, and/or the like are generally intended to refer to a computer-related entity, either hardware, a combination of hardware and software, software, or software in execution, e.g., a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc., e.g., a first object and a second object generally correspond to object A and object B or two different or two identical objects or the same object.

Moreover, “example” and “e.g.,” is used herein to mean serving as an example, instance, illustration, etc., and not necessarily as advantageous. As used herein, “user” can be a content creator, a content publisher, or a visitor. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure.

What is claimed is:

1. An overlayment image system comprising:
an upload device for capturing an image;
a processor for converting the image to a digital file to be used as an overlay;
a processor for requesting a download device to download the digital file, and requesting the upload device to upload the digital file to the download device;
a processor connected to the download device for overlaying the digital file on an original digital file as instructed by a user and displaying the original file with the overlaid image.

2. An overlayment image system comprising:
an uploading device for acquiring overlayment data files;
the uploading device provides the overlayment data files to an overlayment storage server;
a file from the overlayment storage server is called on by a temporary array processor and the file populates a temporary array;
an overlayment placement device acquires overlayment placement information from a processor;
the temporary array processor downloads the temporary array data to the overlayment placement device where a processor provides for its display where it has been indicated the overlayment should be placed.

3. The system of claim 2 wherein:
the uploading device can be a digital camera, a digital drawing device, a microphone, an audio file, or a processor that can download or stream overlayment data from the Internet or other storage systems

4. The system of claim 2 wherein: the overlayment data files can be an image or images, video, live stream, audio, or other data.

5. The system of claim 2 wherein:
the placement device can be a pointer, controlled by a user, that is moved along the outline of an image.

6. A method comprising:
identifying content to overlay displayed digital content;
creating a temporary array;
populating the temporary array with the identified content for overlayment; and
responsive to an input, transforming the temporary array into a populated overlayment.
